(19) United States
(12) Patent Application Publication
(10) Pub. No.: US 2017/0332231 A1
(43) Pub. Date: Nov. 16, 2017

(54) NON-DECRYPTABLE DATA ENCRYPTION TECHNIQUE FOR A SCALABLE DATA-RELATED OPERATION

(71) Applicant: RESEARCH NOW GROUP, INC., Plano, TX (US)

(72) Inventors: James Robert Cameron HAMILTON, Denton, TX (US); Richard Andrew NIETUBICZ, Carrollton, TX (US); Florent J.A. TUAL, London (GB)

(21) Appl. No.: 15/152,238

(22) Filed: May 11, 2016

(51) Int. Cl. H04W 12/02; H04L 9/08; H04L 9/32; H04L 29/06

(52) U.S. Cl. CPC H04W 12/02; H04L 63/0428; H04L 9/0866; H04L 9/3247; H04L 2209/80

(57) ABSTRACT

This disclosure is directed to a non-decrytable data encryption technique for performing a data-related operation. An exemplary method comprises receiving or accessing an input file, the input file comprising a list of data entries; generating an initialization vector for a data entry; generating a fingerprint for the data entry; generating an encryption signature based on the initialization vector and the fingerprint; determining an encryption type for the data entry; generating, using the encryption type, an encryption value for the data entry; and producing an output file comprising the encryption value and the encryption signature, wherein the encryption value cannot be decrypted to produce the data entry.

### TECHNICAL FIELD

This disclosure is directed to data encryption, suitably classified in USPC 380 (art unit 2431) corresponding to CPC H04L 9/00.

### BACKGROUND

There may be a need to use a computing system (e.g., a mobile phone) to compare large volumes of data (e.g., millions or billions of data entries) from a first data system with large volumes of data (e.g., millions or billions of data entries) from a second data system to determine any data matches. However, a user of the first data system may not want to share data with the second data system, and vice versa. Therefore, there is a need for a solution to compare data (e.g., millions or billions of data entries) from the first data system with data (e.g., millions or billions of data entries) from the second data system (1) without sharing data between the first data system and the second data system, and (2) using a computing system such as a mobile device.

### BRIEF SUMMARY

In some embodiments, a method is provided for non-decryptably encrypting data entries. The method comprises: receiving or accessing, at a first computing system, an input file, the input file comprising a list of data entries; generating an initialization vector for a data entry; generating a fingerprint for the data entry; generating an encryption signature based on the initialization vector and the fingerprint; determining an encryption type for the data entry; generating, using the encryption type, an encryption value for the data entry; and producing, at the first computing system, an output file comprising the encryption value and the encryption signature, wherein the encryption value cannot be decrypted to produce the data entry.

In some embodiments, the fingerprint is for controlling division of the list of data entries into blocks of data entries.

In some embodiments, a size of the list of data entries is greater than a size of a memory of the first computing system.

In some embodiments, the output file is produced in a memory of the first computing system.

In some embodiments, the method further comprises prior to generating the encryption value, normalizing the data entry, the normalizing comprising at least one of modifying a character of the data entry, deleting the character of the data entry, or adding a new character to the data entry.

In some embodiments, the method further comprises determining a second encryption type for a second normalized data entry from the list of data entries.

In some embodiments, the method further comprises inserting a new data entry in the output file for determining a false positive match with the new data entry.

In some embodiments, the method further comprises sorting encryption values in the output file such that an order of the encryption values does not have one-to-one correspondence with an order of the list of data entries.

In some embodiments, the method further comprises binding the initialization vector and the fingerprint to the data entry using a lambda calculus operation.

In some embodiments, the method further comprises transmitting the output file to a second computing system.

In some embodiments, a second computing system: receives the output file from the first computing system, the output file comprising the encryption value; receives or accesses a second input file, the second input file comprising a second list of data entries; identifies the encryption signature in the output file; and determines the fingerprint based on the encryption signature.

In some embodiments, a second computing system: identifies, using the fingerprint, a subset of the second list of data entries in the second input file, the subset of the second list of data entries comprising a second data entry; generates, using the encryption type, a second encryption value for the second data entry; compares the encryption value with the second encryption value; determines whether the encryption value matches the second encryption value; in response to determining the encryption value matches the second encryption value, removes the second encryption value from the second output file or the output file to produce a modified second output file or a modified output file; and transmits the modified output file or the modified second output file.

In some embodiments, a size of the subset of the second list of the data entries is equal to or less than a memory of the second computing system.

In some embodiments, a size of the second list of the data entries or the output file is greater than a memory of the second computing system.

In some embodiments, the second computing system: generates, using the encryption type, a second encryption value for a second data entry in the second input file; compares the encryption value with the second encryption value; determines whether the encryption value matches the second encryption value; in response to determining the encryption value matches the second encryption value, removes the second encryption value from the second output file or the output file to produce a modified second output file or a modified output file; and transmits the modified output file or the modified second output file.

In some embodiments, the second computing system, prior to transmitting the modified output file or the modified second output file, inserts a second encryption signature in the modified output file or the modified second output file.

In some embodiments, the method further comprises receiving the modified output file or the modified second output file from the second computing system; determining, using the modified output file or the modified second output file, the initialization vector; re-receiving or re-accessing the input file; re-generating, using the encryption type, a third encryption value for a data entry in the input file; and comparing the third encryption value to a fourth encryption value in the modified output file or the modified second output file.

In some embodiments, the method further comprises in response to determining the third encryption value does not match the fourth encryption value, retaining the third encryption value; determining a second data entry associated with the third encryption value; and producing a second output file comprising the second data entry.

In some embodiments, the method further comprises sorting regenerated encryption values such that the regenerated encryption values correspond to data entries in the input file.

In some embodiments, the method further comprises deleting or removing the encryption signature from the modified output file.

In some embodiments, determining the initialization vector comprises: determining the fingerprint; building a fingerprint table using the fingerprint; and merging the modified output file or the second modified output file with the fingerprint table.

In some embodiments, a computing system is provided for non-decryptably encrypting data entries. The computing system is for: receiving or accessing an input file, the input file comprising a list of data entries; generating an initialization vector for a data entry; generating a fingerprint for the data entry; generating an encryption signature based on the initialization vector and the fingerprint; determining an encryption type for the data entry; generating, using the encryption type, an encryption value for the data entry; and producing an output file comprising the encryption value and the encryption signature, wherein the encryption value cannot be decrypted to produce the data entry.

In some embodiments, the encryption signature is associated with a particular data session or data transaction. In other embodiments, the encryption signature may be associated with multiple data sessions or data transactions.

In some embodiments, a non-transitory computer-readable medium comprising code is configured to cause a computer to perform the various methods described herein.

### BRIEF DESCRIPTION OF THE DRAWINGS

FIG. 1 is a block diagram of a complex computing network for executing a non-decrytable data encryption technique, in accordance with some embodiments of the invention;

FIG. 2 is a block diagram of a complex computing environment for executing a non-decrytable data encryption technique, in accordance with some embodiments of the invention; and

FIGS. 3A, 3B, and 3C are block diagrams of a method for executing a non-decrytable data encryption technique, in accordance with some embodiments of the invention.

All of these drawings are illustrations of certain embodiments. The scope of the claims is not limited to the specific embodiments illustrated in the drawings and described herein.

### DETAILED DESCRIPTION OF THE EMBODIMENTS

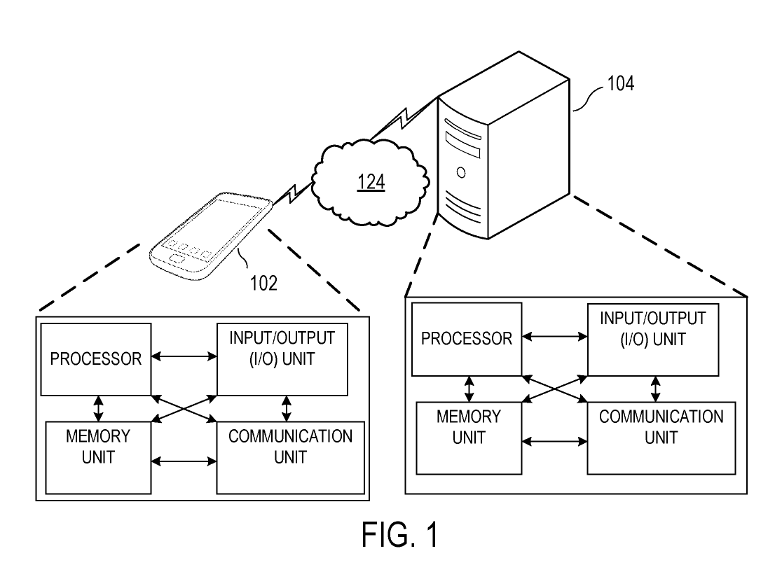

FIG. 1 is a block diagram of a complex computing network environment for executing a non-decrytable data encryption technique. The network environment comprises a network 124 (e.g., a wired or wireless network) for enabling communication between the various systems presented in FIG. 1. The network environment further comprises a first computing system 102 and a second computing system 104. The first computing system 102 and/or the second computing system 104 may be any type of computing system such as a desktop, server, laptop, tablet, mobile phone, watch, headgear, eyewear, e-reader, sensor, agent, other mobile device, other wearable device, etc.

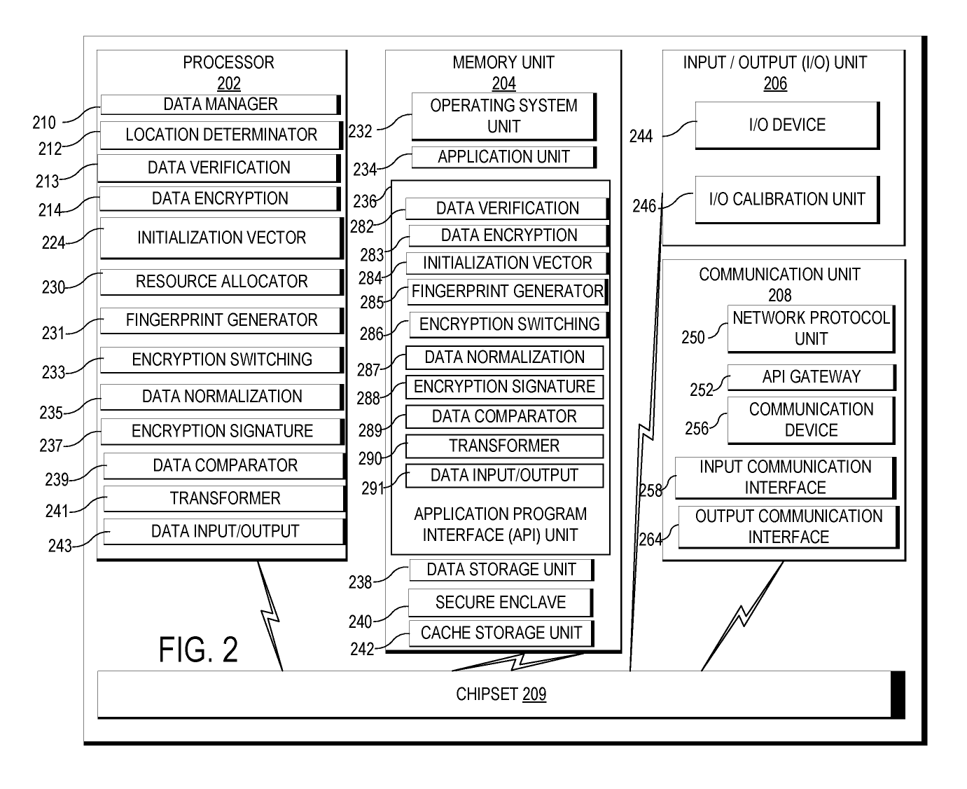

Each of the first computing system 102 and the second computing system 104 may comprise a processor, a memory unit, an input/output (I/O) unit, and a communication unit. The processor, the memory unit, the I/O unit, and the communication unit are described in further detail in FIG. 2. As explained in FIG. 2, the memory unit, the I/O unit, the communication unit, and the processor may interact via a chipset. In some embodiments, the functionality of one or more of the first computing system 102 and the second computing system 104 may be combined into a single system.

In some embodiments, the term “data” may refer to “signal” or “information.” In some embodiments, the terms “signal,” “data,” and “information” may be used interchangeably. In some embodiments, the terms “data,” “data record,” and “data entry” may be used interchangeably. Any reference to data may also include references to the contents of the data. Any signals may be electronic or electromagnetic signals. Additionally, any signals may be either be transitory or non-transitory signals. Additionally, any signals described herein may be analog signals, digital signals, and/or mixed analog and digital signals. The terms “system,” “apparatus,” “server,” “agent,” “transducer,” “device,” “unit,” “sub-unit,” “element,” etc., may be used interchangeably in some embodiments. In some embodiments, a method is provided for performing the various steps performed by any system described herein. In some embodiments, a non-transitory computer-readable medium comprising code is provided for causing a system to perform the various methods described herein. In some embodiments, a system may comprise a housing that includes various units, sub-units, elements, etc., such as those illustrated in FIG. 2. In some embodiments, a chipset may be disposed in the housing and may be interfaced with a processor such as a signal processor, a data processor, etc. The chipset may have hardware (e.g., electronic components in an electronic circuit) for supporting various connections within the system (e.g., between units, sub-units, etc.), or any other connection from the system to external systems or devices.

FIG. 2 illustrates an exemplary complex computing environment for executing a non-decrytable data encryption technique. For example, the computing environment may be included in and/or utilized by the first computing system, the second computing system, and/or any other system described herein. The computing environment and/or any of its units and/or sub-units described herein may include general hardware, specifically-purposed hardware, and/or specially purposed-software.

The computing environment may include, among other units, a processor 202, a memory unit 204, an input/output (I/O) unit 206, and/or a communication unit 208. As described herein, each of the processor 202, the memory unit 204, the I/O unit 206, and/or the communication unit 208 may include and/or refer to a plurality of respective units, sub-units, and/or elements. The various units, sub-units, and/or elements may be implemented entirely in hardware, entirely in software, or in a combination of hardware and software. Some of the units, sub-units, and/or elements may be optional. Any software described herein may be specially purposed software for performing a particular function. In some embodiments, hardware may also be specially purposed hardware for performing some particular functions. Furthermore, each of the processor 202, the memory unit 204, the I/O unit 206, and/or the communication unit 208 may be operatively and/or otherwise communicatively coupled with each other using a chipset 209. The chipset 209 may have hardware for supporting connections to the processor 202, the memory unit 204, the I/O unit 206, the communication unit 208, the first computing system 102 and/or the second computing system 104. While sub-units may be shown in a particular unit on FIG. 2, the sub-units may alternatively or additionally be present in a different unit and/or sub-unit. For example, a sub-unit that is present in the memory unit 204 may alternatively or additionally be present in the processor 202, and vice versa. Some sub-units may be optional, while other sub-units, not presented in FIG. 2, may also be included in any of the units and/or sub-units described herein. In some embodiments, any method described herein may be entirely performed by one of the processor 202 or the memory unit 204. In other embodiments, any method described herein may be performed by a combination of the processor 202 and the memory unit 204.

The processor 202 may control any of the other units, sub-units of the units, and/or functions performed by the units. Any actions described herein as being performed by a processor may be taken by the processor 202 alone and/or by the processor 202 in conjunction with one or more additional processors, units, sub-units, elements, components, devices, and/or the like. Additionally, while only one processor 202 may be shown in FIG. 2, multiple processors may be present and/or otherwise included in the computing environment. Thus, while instructions may be described as being executed by the processor 202 (and/or various sub-units of the processor 202), the instructions may be executed simultaneously, serially, and/or by one or multiple processors in parallel. In some embodiments, the processor 202 may refer to any microprocessor, such as a specially purposed microprocessor. In some embodiments, the processor 202 may refer to any type of processor, including a digital processor, an analog processor, a mixed analog-digital processor, etc.

In some embodiments, the processor 202 may be implemented as one or more computer processor (CPU) chips and/or graphical processor (GPU) chips and may include a hardware device capable of executing computer instructions. The processor 202 may execute instructions, codes, computer programs, and/or scripts. The instructions, codes, computer programs, and/or scripts may be received from and/or stored in the memory unit 204, the I/O unit 206, the communication unit 208, sub-units of the aforementioned units, other devices and/or computing environments, and/or the like. As described herein, any unit and/or sub-unit of the computing environment and/or any other computing environment may be utilized to perform any methods described herein. In some embodiments, the computing environment may not include a generic computing system, but instead may include a customized computing system designed to perform the various methods described herein.

In some embodiments, the processor 202 may include, among other sub-units, sub-units such as a data manager 210 (for managing, receiving, processing, analyzing, organizing, transforming any data), a location determinator 212 (described herein), a data verification component 213 (for performing step 304, etc.), a data encryption component 214 (for performing steps 316, 332, 354, 356, etc.), an initialization vector generator 224 (for performing steps 306, 350, etc.), a resource allocator 230 (described herein), a fingerprint generator 231 (for performing steps 308, 328, 346, etc.), an encryption switching component 233 (for performing step 312, etc.), a data normalization component 235 (for performing steps 314, 330, etc.), an encryption signature component 237 (for performing steps 310, 328, 342, etc.), a data comparator 239 (for performing steps 336, 338, 358, etc.), a transformer 241 (for performing steps 340, 350, 360, 362, etc.), and a data input/output component 243 (for performing steps 302, 320, 322, 324, 326, 334, 344, 348, 352, 362, etc.). In some embodiments, some of the sub-unit may perform other steps of the method even though those steps are not listed as being associated with or being performed by a particular sub-unit. In some embodiments, the functions performed by the data input/output component 243 may additionally and/or alternatively be performed by or in coordination with the input communication interface 258 and/or the output communication interface 264.

Any unit of the processor 202 may be a hardware unit such as a circuit (e.g., a specialized circuit for performing a particular function) or a software unit such as a set of instructions (e.g., a specialized set of instructions for performing a particular function).

The location determinator 212 may facilitate detection, generation, modification, analysis, transmission, and/or presentation of location information. Location information may include global positioning system (GPS) coordinates, an Internet protocol (IP) address, a media access control (MAC) address, geolocation information, an address, a port number, a zip code, a server number, a proxy name and/or number, device information (e.g., a serial number), and/or the like. In some embodiments, the location determinator 212 may include various sensors, a radar, and/or other specifically-purposed hardware elements for enabling the location determinator 212 to acquire, measure, and/or otherwise transform location information of a computing device (e.g., the first computing system, the second computing system, etc.) in which the location determinator 212 is located or a computing device different from that in which the location determinator 212 is located.

The resource allocator 230 may facilitate the determination, monitoring, analysis, and/or allocation of computing resources throughout the computing environment. As such, computing resources of the computing environment utilized by the processor 202, the memory unit 204, the I/O unit 206, and/or the communication unit 208 (and/or any sub-unit of the aforementioned units) such as processing power, data storage space, network bandwidth, and/or the like may be in high demand at various times during operation. Accordingly, the resource allocator 230 may be configured to manage the allocation of various computing resources as they are required by particular units and/or sub-units of the computing environment (e.g., the processor 202). In some embodiments, the resource allocator 230 may include sensors and/or other specially-purposed hardware for monitoring performance of each unit and/or sub-unit of the computing environment, as well as hardware for responding to the computing resource needs of each unit and/or sub-unit. In some embodiments, the resource allocator 230 may utilize computing resources of a second computing environment separate and distinct from the computing environment to facilitate a desired operation. Therefore, in some embodiments any processor may be referred to as a load-balancing processor. Any apparatus described herein may be referred to as load-balancing apparatus or server. The term load-balancing may refer to allocation of computing resources to the various units of the computing environment.

For example, the resource allocator 230 may determine a number of computing operations for performing by a system described herein (e.g., the first computing system, the second computing system, etc.). The resource allocator 230 may then determine that the number of computing operations or computing resources (e.g., processing power, storage space of a particular non-transitory computer-readable memory medium, network bandwidth, and/or the like) required by the determined number of computing operations meets and/or exceeds a predetermined threshold value. Based on this determination, the resource allocator 230 may determine an amount of additional computing resources (e.g., processing power, storage space of a particular non-transitory computer-readable memory medium, network bandwidth, and/or the like) required by the processor 202, the memory unit 204, the I/O unit 206, the communication unit 208, and/or any sub-unit of the aforementioned units for enabling safe and efficient operation of the computing environment while supporting the number of simultaneous computing operations. The resource allocator 230 may then retrieve, transmit, control, allocate, and/or otherwise distribute determined amount(s) of computing resources to each element (e.g., unit and/or sub-unit) of the computing environment and/or another computing environment. In some embodiments, the allocation of computing resources of the resource allocator 230 may include the resource allocator 230 flipping a switch, adjusting processing power, adjusting memory size, partitioning a memory element, transmitting and/or receiving data, controlling one or more input and/or output devices, modifying various communication protocols, and/or the like. In some embodiments, the resource allocator 230 may facilitate utilization of parallel processing techniques, e.g., for parallel computing operations. A computing operation may refer to any operation, function, method, process, etc., described in this disclosure.

In some embodiments, the memory unit 204 may be utilized for storing, recalling, receiving, transmitting, and/or accessing various data during operation of the computing environment. The memory unit 204 may include various types of storage media such as solid state storage media, hard disk storage media, and/or the like. The memory unit 204 may include dedicated hardware elements such as hard drives and/or servers, as well as software elements such as cloud-based storage drives. For example, the memory unit 204 may include various sub-units such as an operating system unit 232, an application unit 234, an application programming interface (API) unit 236, a data storage unit 238 (for storing data), a secure enclave 240, and a cache storage unit 242.

The memory unit 204 and/or any of its sub-units described herein may include random access memory (RAM), read only memory (ROM), and/or various forms of secondary storage. RAM may be used to store volatile data and/or to store instructions that may be executed by the processor 202. For example, the data stored may be a command, a current operating state of the computing environment (or of a particular unit or sub-unit of the computing environment), an intended operating state of the computing environment (or of a particular unit or sub-unit of the computing environment), and/or the like. As a further example, data stored in the memory unit 204 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 204 may include one or more databases for storing any data described herein. Additionally or alternatively, one or more secondary databases located remotely from the computing environment may be utilized and/or accessed by the memory unit 204.

The operating system unit 232 may facilitate deployment, storage, access, execution, and/or utilization of an operating system utilized by the computing environment and/or any other computing environment described herein. In some embodiments, the operating system may include various hardware and/or software elements that serve as a structural framework for enabling the processor 202 to execute various operations described herein. The operating system unit 232 may further store various pieces of information and/or data associated with operation of the operating system and/or the computing environment as a whole, such as a status of computing resources (e.g., processing power, memory availability, resource utilization, and/or the like), runtime information, modules to direct execution of operations described herein, user or computing device permissions to access and/or modify any of the systems described herein, security credentials to access and/or modify any of the systems described herein, and/or the like.

The application unit 234 may facilitate deployment, storage, access, execution, and/or utilization of an application utilized by the computing environment. For example, users may be required to download, access, and/or otherwise utilize a software application on a computing device such as a smartphone, tablet, or computing device, in order for various operations described herein to be performed. The computing device may be in communication with the first computing system, the second computing system, etc. Information included in the application unit 234 may enable a user to execute various computing operations described herein. The application unit 234 may further store various pieces of information associated with operation of the application and/or the computing environment as a whole, such as a status of computing resources (e.g., processing power, memory availability, resource utilization, and/or the like), runtime information, modules to direct execution of operations described herein, user permissions, security credentials, and/or the like.

The API unit may facilitate deployment, storage, access, execution, and/or utilization of information associated with APIs of the computing environment. For example, the computing environment may include one or more APIs for enabling the systems illustrated in FIG. 1 to communicate with each other and/or perform computing operations described herein. Accordingly, the API unit may include API databases comprising information that may be accessed and/or utilized by applications and/or operating systems of other devices and/or computing environments. In some embodiments, each API database may be associated with a customized physical circuit included in the memory unit 204 and/or the API unit. Additionally, each API database may be public and/or private, and so authentication credentials may be required to access information in an API database. The data storage unit 238 may facilitate deployment, storage, access, and/or utilization of data by any system, unit, sub-unit, etc., in the computing environment. In some embodiments, each sub-unit of the API may be associated with or may comprise a customized set of software instructions and/or a customized physical circuit.

In some embodiments, the API unit 236 may comprise a data verification API 282 (for performing step 304, etc.), a data encryption API 283 (for performing steps 316, 332, 354, 356, etc.), an initialization vector generator API 284 (for performing steps 306, 350, etc.), a fingerprint generator API 285 (for performing steps 308, 328, 346, etc.), an encryption switching API 286 (for performing step 312, etc.), a data normalization API 287 (for performing steps 314, 330, etc.), an encryption signature API 288 (for performing steps 310, 328, 342, etc.), a data comparator API 289 (for performing steps 336, 338, 358, etc.), a transformer API 290 (for performing steps 340, 350, 360, 362, etc.), and a data input/output API 291 (for performing steps 302, 320, 322, 324, 326, 334, 344, 348, 352, 362, etc.). In some embodiments, some of the sub-units may perform other steps of the method even though those steps are not listed as being associated with or performed by a particular sub-unit. In some embodiments, functions performed by the data input/output API 291 may additionally and/or alternatively be performed by or in coordination with the input communication interface 258 and/or the output communication interface 264.

The secure enclave 240 may facilitate secure storage of data. In some embodiments, the secure enclave 240 may include a partitioned portion of storage media included in the memory unit 204 that is protected by various security measures. For example, the secure enclave 240 may be hardware secured. In other embodiments, the secure enclave 240 may include one or more firewalls, encryption mechanisms, and/or other security-based protocols. Authentication credentials of a user may be required prior to providing the user access to data stored within the secure enclave 240.

The cache storage unit 242 may facilitate short-term deployment, storage, access, analysis, and/or utilization of data. For example, the cache storage unit 242 may serve as a short-term storage location for data so that the data may be accessed quickly. In some embodiments, the cache storage unit 242 may include RAM and/or other storage media types that enable quick recall of stored data. The cache storage unit 242 may included a partitioned portion for storing specific data.

Any aspect of the memory unit 204 may comprise any collection and arrangement of volatile and/or non-volatile components suitable for storing data. For example, the memory unit 204 may comprise random access memory (RAM) devices, read only memory (ROM) devices, magnetic storage devices, optical storage devices, and/or any other suitable data storage devices. In particular embodiments, the memory unit 204 may represent, in part, computer-readable storage media on which computer instructions and/or logic are encoded. The memory unit 204 may represent any number of memory components within, local to, and/or accessible by a processor.

The I/O unit 206 may include hardware and/or software elements for enabling the computing environment to receive, transmit, present data, etc. For example, elements of the I/O unit 206 may be used to receive, transmit, present data. In this manner, the I/O unit 206 may enable the computing environment to interface with a human user. As described herein, the I/O unit 206 may include sub-units such as an I/O device 244 and an I/O calibration unit 246.

The I/O device 244 may facilitate the receipt, transmission, processing, presentation, display, input, and/or output of data as a result of executed processes described herein. In some embodiments, the I/O device 244 may include a plurality of I/O devices. In some embodiments, the I/O device 244 may include one or more elements of a data system, a computing device, a server, and/or a similar device.

The I/O device 244 may include a variety of elements that enable a user to interface with the computing environment. For example, the I/O device 244 may include a keyboard, a touchscreen, a touchscreen sensor array, a mouse, a stylus, a button, a sensor, a depth sensor, a tactile input element, a location sensor, a biometric scanner, a laser, a microphone, a camera, and/or another element for receiving and/or collecting input from a user and/or information associated with the user and/or the user's environment. Additionally and/or alternatively, the I/O device 244 may include a display, a screen, a projector, a sensor, a vibration mechanism, a light emitting diode (LED), a speaker, a radio frequency identification (RFID) scanner, and/or another element for presenting and/or otherwise outputting data to a user. In some embodiments, the I/O device 244 may communicate with one or more elements of the processor 202 and/or the memory unit 204 to execute operations described herein.

The I/O calibration unit 246 may facilitate the calibration of the I/O device 244. For example, the I/O calibration unit 246 may detect and/or determine one or more settings of the I/O device 244, and then adjust and/or modify settings so that the I/O device 244 may operate more efficiently. In some embodiments, the I/O calibration unit 246 may utilize a calibration driver (or multiple calibration drivers) to calibrate the I/O device 244.

The communication unit 208 may facilitate establishment, maintenance, monitoring, and/or termination of communications between the computing environment and other systems, units, sub-units, etc., illustrated in FIGS. 1 and 2. The communication unit 208 may further enable communication between various elements (e.g., units and/or sub-units) of the computing environment. In some embodiments, the communication unit 208 may include a network protocol unit 250, an API gateway 252, a communication device 256, an input communication interface 258 (e.g., for establishing a connection to a computing system, and receiving data on the connection) and an output communication interface 264 (e.g., for establishing a connection to a computing system, and transmitting data on the connection). In some embodiments, one or more of the communication interfaces may be combined into a single interface. The communication unit 208 may include hardware and/or software elements.

The network protocol unit 250 may facilitate establishment, maintenance, and/or termination of a communication connection between the computing environment and another device by way of a network. For example, the network protocol unit 250 may detect and/or define a communication protocol required by a particular network and/or network type. Communication protocols utilized by the network protocol unit 250 may include Wi-Fi protocols, Li-Fi protocols, cellular data network protocols, Bluetooth® protocols, WiMAX protocols, Ethernet protocols, powerline communication (PLC) protocols, Voice over Internet Protocol (VoIP), and/or the like. In some embodiments, facilitation of communication between the computing environment and any other device, as well as any element internal to the computing environment, may include transforming and/or translating data from being compatible with a first communication protocol to being compatible with a second communication protocol. In some embodiments, the network protocol unit 250 may determine and/or monitor an amount of data traffic to consequently determine which particular network protocol is to be used for transmitting and/or receiving data.

The API gateway 252 may facilitate the enablement of other devices and/or computing environments to access the API unit of the memory unit 204 of the computing environment. For example, a computing device may access the API unit via the API gateway 252. In some embodiments, the API gateway 252 may be required to validate user credentials associated with a user of a computing device prior to providing access of the API unit to the user. The API gateway 252 may include instructions for enabling the computing environment to communicate with another device.

The communication device 256 may include a variety of hardware and/or software specifically purposed to enable communication between the computing environment and another device, as well as communication between elements of the computing environment. In some embodiments, the communication device 256 may include one or more radio transceivers, chips, analog front end (AFE) units, antennas, processors, memory, other logic, and/or other components to implement communication protocols (wired or wireless) and related functionality for facilitating communication between the computing environment and any other device. Additionally and/or alternatively, the communication device 256 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

It is contemplated that the computing elements be provided according to the structures disclosed herein may be included in integrated circuits or chipsets of any type to which their use commends them, such as ROMs, RAM (random access memory), DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as processors (DSP), graphics system processors (GSP), synchronous vector processors (SVP), and image system processors (ISP) all represent sites of application of the principles and structures disclosed herein.

Implementation of any unit or sub-unit of any device described herein is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

The computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations. For example, the first computing system and the second computing system may be in different geographical locations.

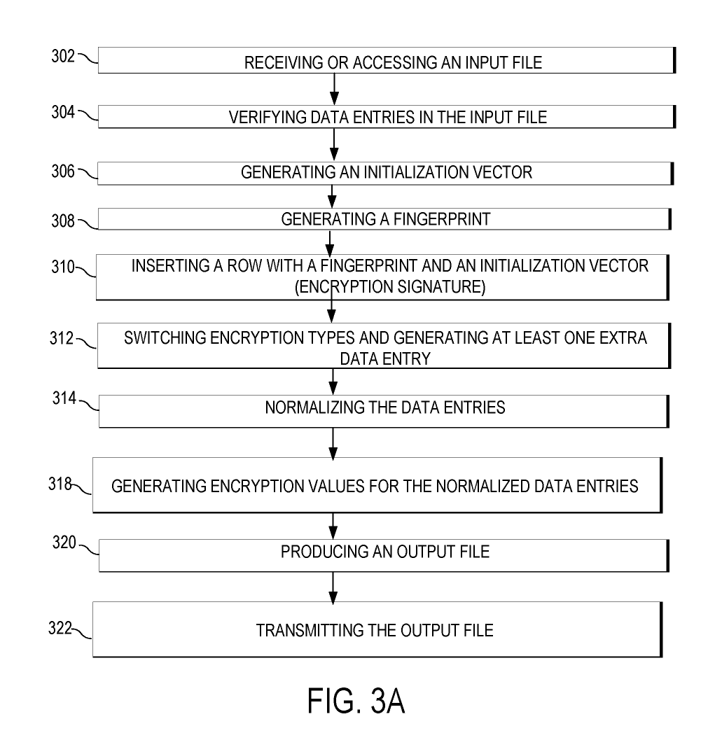

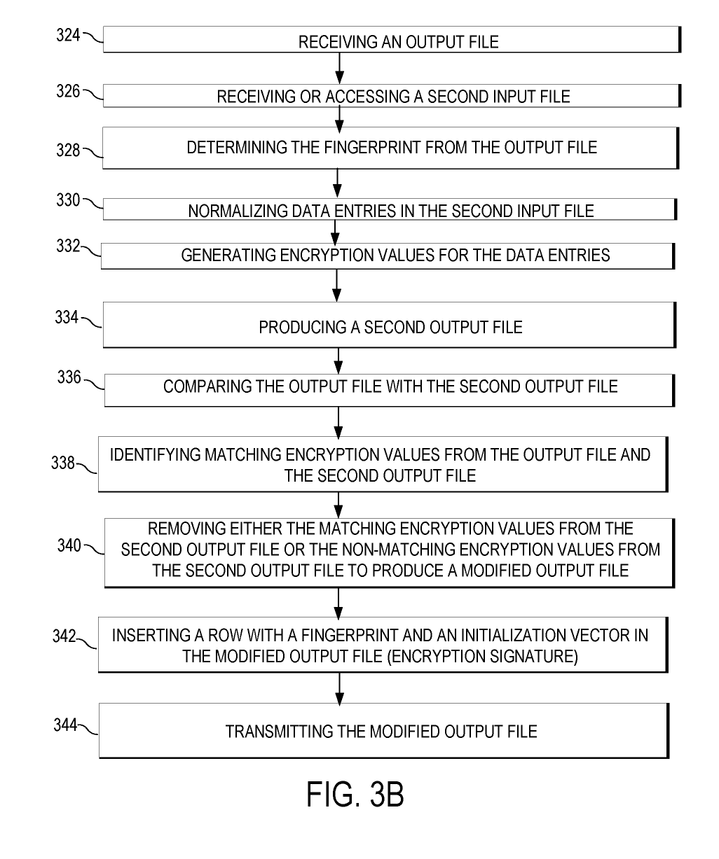

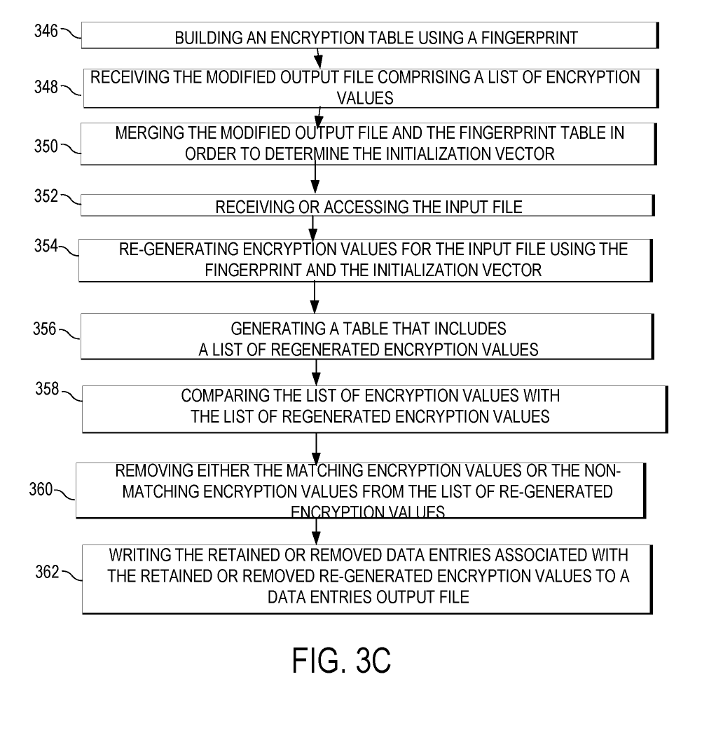

FIGS. 3A, 3B, and 3C are block diagrams of a method for executing a non-decrytable data encryption technique for performing a data matching operation in a complex computing network. The various blocks of FIGS. 3A, 3B, and 3C may be executed in a different order from that shown in FIGS. 3A, 3B, and 3C. Some blocks may be optional. In some embodiments, each of the various blocks of 3A, 3B, and 3C may be performed by different systems presented in FIG. 1 or any of the units, sub-units, and/or elements presented in FIG. 2, or any combination thereof. For example, the method described herein may be performed in the memory unit 204 of FIG. 2, which keeps any output of the method secure. In some embodiments, the various blocks of 3A, 3B, and 3C may be performed wholly by any one of the systems presented in FIG. 1 or any one of the units, sub-units, and/or elements presented in FIG. 2. The method may be performed by any computing device, including mobile computing devices. The method may be performed using an operating system running on the computing device. In some embodiments, the terms “operation,” “technique,” “method,” “process,” etc., may be used interchangeably. The non-decryptable data encryption technique may be used for any data-related operations, including non-data matching operations. The applicability of the technique to data matching operations is described for exemplary purposes only.

A data entry may refer to any information. Information may include identification information associated with a user (any personal identification information or PII) or an entity. For example, the information may comprise an email address, a name, a phone number, a payment card number such as a credit or debit card number, a mailing address, mobile device identification number, network address location, global positioning system (GPS) coordinates, a password or passcode, or the like. A data entry may comprise one or more fields or attributes. In some embodiments, any reference to a data entry may be a reference to an attribute or a field of a data entry. As used herein, data or data entry may refer to a single data entry. In alternate embodiments, data or data entry may refer to a list of or multiple data entries. Blocks 302-322 (FIG. 3A) may be performed by a first computing device. Independently, blocks 302-322 (FIG. 3B) may also be performed by a second computing device.

At block 302, the method comprises receiving or accessing an input file at a first computing device. The input file may comprise one or more data entries (e.g., a list of data entries). At block 304, the method comprises verifying the data entries. Verifying the data entries comprises determining whether the data entries are of the correct format. For example, if a data entry comprises an email address, the verifying step determines whether the “@” symbol is present in the data entry. Verifying the data entry also comprises determining whether there are any spaces in the data entry. Spaces may be present before the first character of the data entry, between any characters of the data entry, after the last character of the data entry, etc. Verifying the data entry may also comprise determining whether any characters of the data entry are lowercase characters, uppercase characters, etc. The verification of the data entry is executed to establish consistency of the field that is used in matching the data entry.

At block 306, the method comprises generating an initialization vector. The initialization vector may be generated using a randomness operation or a pseudo-randomness operation. The initialization vector may be a random number such as a random binary number. The initialization vector may be appended to the end of the data entry (i.e., after the last character of the data entry). In other embodiments, the initialization vector may be appended to the beginning of the data entry (i.e., before the first character of the data entry). In other embodiments, the initialization vector may be inserted between characters of the data. In other embodiments, multiple initialization vectors may be used, which may be placed at least one of prior to the first character of the data entry, after the last character of the data entry, in between characters of the data entry, etc. The initialization vector is not limited to any particular length. In some embodiments, the initialization vector may comprise a certain number of characters (e.g., sixteen characters). In some embodiments, the initialization vector may be unique (and not random) to a particular computing system or entity.

At block 308, the method comprises generating a fingerprint. The fingerprint may be generated using a random fingerprint generator. The fingerprint may be an alphanumeric code. The fingerprint may be generated based on the data entry or type of data entry. The fingerprint may be used to index a list of data entries. The fingerprint may be a static code. The fingerprint may be appended to the beginning of the data entry (e.g., before the first character of the data entry). In other embodiments, the fingerprint may be appended to the end of the data entry (i.e., after the last character of the data entry). In other embodiments, the fingerprint may be inserted between characters of the data. In other embodiments, multiple fingerprints may be used, which may be placed at least one of prior to the first character of the data entry, after the last character of the data entry, in between characters of the data entry, etc. The fingerprint is not limited to any particular length. The fingerprint may be used to sort the list of data entries. In some embodiments, the fingerprint may be unique (and not random) to a particular computing system or entity. This means that even if a particular computing system or entity receives a file comprising data entries that belong to a different computing system or entity, the particular computing system or entity may not be able to perform the data matching method described herein unless the particular system or entity has access or knowledge of the fingerprint.

The fingerprint may be used to divide a list of data entries into blocks of data entries, wherein a block of data entries comprises one or more data entries. A block of data entries may comprise fewer data entries compared to a list of data entries. The fingerprint may comprise multiple characters. One or more characters (e.g., the first two characters) of the fingerprint may be used to search a list of data entries in order to find a particular block of data entries. The blocking of the data entries enables the present method to be applied to very large data entry lists. Controlling the size of the blocks may enable a user or computing device to control the speed of the method described herein (e.g., the data matching method). The size of the blocks may be controlled based on the number of characters of the fingerprint that are used for searching the list of data entries. In some embodiments, the fingerprint may be unique to a single data session or transaction, or multiple data sessions or transactions. In some embodiments, the fingerprint may be used to identify a first computing system or a second computing system described in this disclosure. In some embodiments, the fingerprint may be used in a lambda calculus operation described in this disclosure.

At block 310, the method comprises inserting a row (e.g., the first row of the list) with a fingerprint and an initialization vector. The row may be inserted into at least one of the list of data entries or the file comprising the list of data entries such as the output file produced at block 320. The combination of the fingerprint and the initialization vector may be used for validation of the file and as an encryption signature of the method described herein. The encryption signature may be unique to a certain data session, a certain data entry, block, list, or file, a certain data transaction or data-related operation (e.g., matching operation), a certain entity associated with a data session, etc. Therefore, the encryption signature may be a session identification code associated with a certain data session. In some embodiments, the encryption signature may be a quantity or value that is not based on the fingerprint and/or the initialization vector. For example, the encryption signature may be based on at least one of a phone number associated with the first computing device, a date, a time, device identification information associated with a transmitting device and/or a receiving device, etc.

At block 312, the method comprises switching encryption types which comprises determining a first encryption type for encrypting some of the data entries in the list and determining a second encryption type for encrypting the rest of the data entries in the list. In some embodiments, an encryption type for the entire list of data entries may have been previously determined. In such embodiments, the determined encryption type may be switched from the previously determined encryption type for at least some of the data entries in the list. In some embodiments, the method comprises determining a first encryption type for encrypting the data entries in the list, and determining a second encryption type for encrypting the already-encrypted data entries in the list encrypted using the first encryption type of encryption. Using two or more encryption types in the list makes it much more difficult to decrypt and/or otherwise compromise the data entries in the list.

Additionally or alternatively, at block 312, the method comprises generating at least one extra data entry in the list of data entries. The extra data entry may assist in determining false positive matches. For example, if two lists of data entries are determined to match each other exactly even though one list has an extra data entry, a determination may be made that the matching process is not accurate.

At block 314, the method comprises normalizing the data entries. Normalizing a data entry may comprise removing any spaces before the first character of the data, between the characters of the data, after the last character of the data, etc. Normalizing the data entry may also comprise changing the characters of the data to lower case characters. Normalizing the data entry may also comprise placing the fields of the data entry in a particular sequence. For example, the sequence may be the fingerprint followed by the data entry followed by the initialization vector. The combination of the fingerprint, the data record, and the initialization vector may be referred to as a bound data entry. In some embodiments, one or more variables (e.g., the fingerprint and/or the initialization vector) are bound to the data entry using a lambda calculus operation. The usage of the lambda calculus operation enables usage of fewer computing resources (e.g., less processing power, fewer memory resources, etc.) for performing the method described herein. In some embodiments, the lambda calculus operation may be used for at least one of ordering the variables and the data entry, binding together the variables and the data entry, and normalizing the bound data entry or quantity. The variables and the data entry may be bound in any order including orders different from those described herein. In some embodiments, the lambda calculus operation may even be used for ordering fields or attributes of the data entry itself.

At block 318, the method comprises generating encryption values for the normalized bound data entries. In some embodiments, an encryption value may be a hash value. An encryption value may be generated using an encryption operation. In some embodiments, an encryption operation may be a hashing operation. The encryption operation may be performed on a bound data entry. Each encryption operation may be unique to a data session or a data transaction. The encryption operation may be associated with a set of encryption parameters. The output of block 318 may be a 64 bit word in byte format (and not character format). In other embodiments, the output of block 318 may be of any other length. The encryption value associated with a data entry cannot be used, on its own, to generate (or regenerate) the date entry. The encryption value cannot be decrypted. The encryption operation may be performed using one or more of the previously determined encryption types. In some embodiments, the encryption type may be a SHA-2 (Secure Hash Algorithm 2) operation. In some embodiments, the encryption type may be at least one of SHA-224, SHA-256, SHA-384, SHA-512, SHA-512/224, SHA-512/256 operations. In some embodiments, one or more variables (e.g., the encryption technique) are bound to the data entry using a lambda calculus operation. The usage of the lambda calculus operation enables usage of fewer computing resources (e.g., less processing power, fewer memory resources, etc.) for performing the method described herein. In some embodiments, a lambda calculus operation may be used for generating the encryption values in block 318. The lambda calculus operation used in block 318 may be the same as or different from the lambda calculus operation used in block 314. In some embodiments, the encryption values may be valid for a certain data session, a certain data transaction, a transaction between specific computing systems, a certain period of time, etc. In other embodiments, the encryption values may be valid for multiple data sessions, multiple data transactions, no specific computing systems, any period of time, etc.

At block 320, the method comprises producing an output file. The output file may comprise a list of encrypted data entries and/or the original list of unencrypted data entries. The output file may be an output spreadsheet, an output database, etc. The output file may be associated with a single data transaction or a single data session. In some embodiments, block 320 may further comprise changing the order of or sorting the encrypted data entries (i.e., the encryption values). The encrypted data entries may be sorted based on one or more attributes (e.g., ascending encryption values, descending encryption values, etc.). In some embodiments, the encrypted data entries may be sorted using a sorting parameter. The encrypted data entries are sorted so that the list of encrypted data entries does not have a one-to-one correspondence with the original list of unencrypted data entries, the order of which remains unchanged. The original list of unencrypted data entries may be separately present in an input file (e.g., the input file received at block 302).

At block 322, the method comprise transmitting the output file to a second computing device. Any transmission, reception, connection, or communication may occur using any short-range (e.g., Bluetooth, Bluetooth Low Energy, near field communication, Wi-Fi Direct, etc.) or long-range communication mechanism (e.g., Wi-Fi, cellular, etc.). Additionally or alternatively, any transmission, reception, connection, or communication may occur using wired technologies. Any transmission, reception, or communication may occur directly between any systems, devices, units, sub-units, elements, etc., described herein, or may occur directly or indirectly via a network, a computing device, etc.

FIG. 3B presents the next steps of the data matching method. The steps of FIG. 3B may be performed by a second computing device. At block 324, the method comprises receiving the output file at the second computing device.

At block 326, the method comprises receiving or accessing a second input file at the second computing device. In some embodiments, the second input file may be stored on the second computing device or may be retrieved from an external database. The second input file may comprise one or more data entries (e.g., a list of data entries).

At block 328, the method comprises determining the fingerprint from the output file. In some embodiments, this block comprises identifying the encryption signature (block 310) in the output file and determining the fingerprint from the encryption signature. In some embodiments, the fingerprint may be determined from other means (i.e., not from the output file). At block 328, the method may further comprise using the fingerprint to determine the initialization vector. At block 328, the method may further comprise determining one or more encryption parameters that were used in block 318 based on the initialization vector (and/or the fingerprint). The one or more encryption parameters may be associated with a particular encryption type.

At block 330, the method comprises normalizing a data entry (and/or the list of data entries) in the second input file. The normalizing operation may be the same normalizing operation performed at block 314. Therefore, one or more, or all, of the features and components of block 314 are applicable to block 330. In some embodiments, the normalizing operation at block 330 may be optional.

At block 332, the method comprises generating encryption values for data entries from the second input file or the normalized data entries from block 330. The encryption values may be generated using an encryption operation (e.g., the same encryption operation as used in block 318). Therefore, one or more, or all, of the features and components of block 318 may be applicable to block 332.

In some embodiments, blocks 330 and/or 332 may not be performed for all the data entries in the second input file. Instead, a starting data entry, an ending data entry, and/or a block of data entries for which blocks 330 and/or 332 are performed may be identified using one or more characters of the fingerprint (e.g., the fingerprint identified in block 328) as described previously with respect to block 308. The one or more characters of the fingerprint may be used to search the data entries in the second input file to find a particular block of data entries. Blocks 330 and/or 332 may then be performed for the particular block of data entries. The one or more characters (e.g., the first two characters) of the fingerprint associated with the particular block of data entries may match with the one or more characters (e.g., the first two characters) of the fingerprint identified in block 328. In some embodiments, a block of data entries may also be referred to as a subset of the list of data entries. In some embodiments, the number of characters of the fingerprint that are considered for the searching operation may determine the size of the block. The greater the number of characters of the fingerprint that are used, the smaller will be the size of the block.

At block 334, the method comprises producing a second output file. The output file may comprise a list of encrypted data entries and/or the original list of unencrypted data entries (comprised in the second input file). The output file may be an output spreadsheet, an output database, etc. The second output file may be associated with a single data transaction or a single data session.

At block 336, the method comprises comparing the output file (comprising a list of encrypted data entries) received at block 324 with the second output file (comprising a list of encrypted data entries) produced at block 334. As used anywhere in this disclosure, an encrypted data entry may refer to an encryption value. In some embodiments, an encrypted data entry may be referred to as just a data entry. Therefore, in some embodiments of the disclosure, a data entry may refer to an encryption value.

In some embodiments, block 336 may not be performed for all the encrypted data entries in the output file and/or the second output file. Instead, a starting data entry, an ending data entry, and/or a block of encrypted data entries for which block 336 is performed may be identified using one or more characters of the fingerprint (e.g., the fingerprint identified in block 328) as described previously with respect to block 308. The one or more characters of the fingerprint may be used to search the encrypted data entries in the output file and/or the second output file to find a particular block of encrypted data entries. Block 336 may then be performed for the particular block of encrypted data entries. The one or more characters (e.g., the first two characters) of the fingerprint associated with the particular block of encrypted data entries may match with the one or more characters (e.g., the first two characters) of the fingerprint identified in block 328.

At block 338, the method comprises identifying matching encrypted data entries (or encryption values) from the output file (or a particular block of the output file) and the second output file (or a particular block of the second output file) based on the comparison operation executed at block 336. Alternatively or additionally, at block 338, the method comprises identifying non-matching encrypted data entries from the output file (or a particular block of the output file) and the second output file (or a particular block of the second output file) based on the comparison operation executed at block 336. In some embodiments, identifying the matching encrypted data entries may comprise merging (e.g., in the memory of the second computing system) the output file (or a particular block of the output file) and the second output file (or a particular block of the second output file). In some embodiments, the term “memory” may also refer to any other storage media located in a computing system. As used herein, encrypted data entries may also be referred to as encryption values. In some embodiments, any part of any method described herein may be performed remotely from the first computing system, the second computing system, etc.

At block 340, the method comprises removing either the matching encrypted data entries (encryption values) from the second output file (and/or the output file) or the non-matching encrypted data entries (encryption values) from the second output file (and/or the output file), to produce a modified second output file (and/or a modified output file). In some embodiments, either the matching encrypted data entries or the non-matching encrypted data entries may be written to a removal file or a retainment file. In some embodiments, the removal or the retainment file may be an output file.

At block 342, the method comprises inserting a row (e.g., the last row of a list) with a fingerprint (e.g., obtained at block 328) and an initialization vector (e.g., obtained at block 328) in the modified output file (or modified second output file). The row may be inserted into at least one of the list of encrypted data entries or the file comprising the list of encrypted data entries in the modified output file or modified second output file produced at block 340. The combination of the fingerprint and the initialization vector may be used for validation of the file and as an encryption signature of the method described herein. The encryption signature may be unique to a certain data session, a certain data entry, block, list, or file, a certain data transaction (e.g., matching operation), a certain entity associated with a data session, etc. Therefore, the encryption signature may be a session identification code associated with or unique to a certain data session.

At block 344, the method comprises transmitting the modified output file (or modified second output file) to a destination computing system (e.g., the first computing system or a different computing system). The destination computing system may comprise an original input file (e.g., the input file referenced at block 302). However, even if the destination computing system comprises the original input file, the destination computing system may not be able to perform a method to determine the differences between the modified output file (or modified second output file) and the original input file unless the destination computing system has access to the encryption signature (e.g., referenced in blocks 342 and 310) and/or the fingerprint and/or the initialization vector (e.g., referenced in blocks 328, 306, and 308). Therefore, the present invention enables prevention of tampering of the modified output file (or modified second output file) even if the modified output file (or modified second output file) is transmitted to an unintended recipient that has authorized or unauthorized access to the original input file. The unintended recipient may be unable to perform a matching operation using the modified output file (or modified second output file) and the input file because the unintended recipient may not have knowledge or access to the encryption signature (e.g., referenced in blocks 342 and 310) and/or the fingerprint and/or the initialization vector (e.g., referenced in blocks 328, 306, and 308).

FIG. 3C presents the next steps of the data matching method. The steps of FIG. 3C may be performed by the first computing device or system. Any block described as being performed by a computing system (e.g., the first computing system, the second computing system, etc.) may be performed in the memory and/or processor of the computing system. In some embodiments, the terms “using” and “based on” may be used interchangeably.

At block 346, the method comprises building an encyrption table (e.g., in a memory) using a fingerprint. This table may also be referred to as the fingerprint table. In some embodiments, this table may comprise a list of one or more (or all) possible fingerprints that can be received by the first computing device. In some embodiments, the fingerprint may have been separately transmitted from the second computing system or device to the first computing system or device. Alternatively, the fingerprint may be determined from the modified output file (or modified second output file) received at block 348. If the fingerprint is determined from the modified output file (or modified second output file), block 346 may be performed after block 348.

At block 348, the method comprises receiving the modified output file (or modified second output file) comprising a list of encryption values. For example, the modified output file (or modified second output file) may be received into the memory of the first computing system or device. In some embodiments, block 348 may be performed before block 346.

At block 350, the method comprises merging the modified output file (or modified second output file) and the fingerprint table in order to determine the initialization vector. In some embodiments, other data operations other than a merging operation may be used to determine the initialization vector.

At block 352, the method comprises receiving (or re-receiving) or accessing (or re-accessing) the input file. In some embodiments, block 352 may be performed at any prior point in time (e.g., before block 346, 348, or 350).

At block 354, the method comprises re-generating encryption values for the input file using the fingerprint and the initialization vector. The encryption values for the input file may be re-generated based on the operations performed in block 318. In some embodiments, the encryption values for the input file may be re-generated based on performing one or more of the operations in blocks 302, 304, 306, 308, 310, 312, 314, 316, and 318.

At block 356, the method comprises generating a table (e.g., a database table in a memory) that includes the regenerated encryption values. A first column of the table may have a list of original data entries (e.g., the original data entries in the input file accessed or received at block 352). A second column of the table may have a list of encryption values re-generated at the block 354. In some embodiments, the table may include only a column that includes the list of re-generated encryption values. In some embodiments, the list of re-generated encryption values may be sorted (e.g., described in block 320) prior to being presented in the column. In some embodiments, the list of encryption values is sorted such that there is a one-to-one correspondence between the list of re-generated encryption values and the list of original data entries. In other embodiments, the list of re-generated encryption values may be sorted so that there is not a one-to-one correspondence between the list of re-generated encryption values and the list of original data entries. In some embodiments, whether the table has one column (e.g., the re-generated encryption values) or two columns (e.g., the re-generated encryption values and the list of original data entries) may be based on a type of computing system or entity that performs the method (e.g., the method described in FIG. 3C) or owns the original data entries.

At block 358, the method comprises comparing the modified output file (or modified second output file) comprising the list of encryption values (received at block 348) with the column of (or list of) re-generated encryption values presented in the column of the table at block 356. As used herein, the terms column and list may be used interchangeably. The comparing operation executed at block 358 may be similar to the operations executed at blocks 336 and 338. Therefore, any features of operations described with respect to blocks 336 and 338 may be performed at block 358. In some embodiments, the comparison operation comprises merging the list of encryption values received at block 348 with the list of encryption values presented in the column of the table at block 358.

At block 360, the method comprises removing either the matching encryption values or the non-matching encryption values from the re-generated encryption values presented in the column of the table at block 356. In some embodiments, the data entries (e.g., in the column of the table at block 356) associated with the matching re-generated encryption values are also removed or highlighted. In other embodiments, the data entries associated with the non-matching encryption values (e.g., in the column of the table at block 356) are removed or highlighted.

At block 362, the method comprises placing or writing the remaining data entries (unremoved non-matching data entries) in the column of the table at block 356 to a retained non-matching data entries output file. Alternatively or additionally, the method comprises placing or writing the remaining data entries (unremoved matching data entries) in the column of the table at block 356 to a retained matching data entries output file.

Alternatively or additionally, at block 362, the method comprises placing or writing the removed data entries associated with the matching encryption values to a removed matching data entries output file. Alternatively or additionally, at block 362, the method comprises placing or writing the data entries associated with the removed non-matching encryption values to a removed non-matching data entries output file.

In some embodiments, substantially simultaneously with or after usage of the encryption signature to perform any steps that require usage of the encryption signature, the encryption signature may be removed from the file (e.g., output file, modified output file) from which it is extracted or determined. The removal of the encryption signature from a file (e.g., an output file or modified output file as described in this disclosure) may prevent a “replay attack.” This means that if the method described herein is valid for a single transaction or session, the removal of the encryption signature from the file prevents the method described herein from being executed for a subsequent transaction or session. In some embodiments, an encryption signature may be valid for multiple transactions during a period of time. Upon expiration of the period of time, the encryption signature may be removed form the file such that the method described herein cannot be executed for transactions after the validity period has expired. In some embodiments, in addition to the removal of the encryption signature, one or more variables or quantities used in or generated by the lambda calculus operation may also be deleted. This deletion also prevents the method described herein from being executed for a subsequent transaction as described with respect to the deletion of the encryption signature. In embodiments where the encryption signature or lambda calculus operation variable or quantity is deleted from the output file, the deletion may be executed by the second computing device (or alternatively by the first computing device). In embodiments where the encryption signature or lambda calculus operation variable or quantity is deleted from the modified output file, the deletion may be executed by the first computing device (or alternatively by the second computing device).

The present disclosure provides several important technical advantages that will be readily apparent to one skilled in the art from the figures, descriptions, and claims. Moreover, while specific advantages have been enumerated above, various embodiments may include all, some, or none of the enumerated advantages. Any sentence or statement in this disclosure may be associated with one or more embodiments. Reference numerals are provided in the specification for the first instance of an element that is numbered in the figures. In some embodiments, the reference numerals for the first instance of the element are also applicable to subsequent instances of the element in the specification even though reference numerals may not be provided for the subsequent instances of the element.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method for non-decryptably encrypting data entries, the method comprising:
receiving or accessing, at a first computing system, an input file, the input file comprising a list of data entries;
generating an initialization vector for a data entry;
generating a fingerprint for the data entry;
generating an encryption signature based on the initialization vector and the fingerprint;
determining an encryption type for the data entry;
generating, using the encryption type, an encryption value for the data entry; and
producing, at the first computing system, an output file comprising the encryption value and the encryption signature, wherein the encryption value cannot be decrypted to produce the data entry.

2. The method of claim 1, wherein the fingerprint is for controlling division of the list of data entries into blocks of data entries, wherein the fingerprint is used for a single data session or multiple data sessions.

3. The method of claim 1, wherein a size of the list of data entries is greater than a size of a memory of the first computing system.

4. The method of claim 1, wherein the output file is produced in a memory of the first computing system.

5. The method of claim 1, further comprising prior to generating the encryption value, normalizing the data entry, the normalizing comprising at least one of modifying a character of the data entry, deleting the character of the data entry, or adding a new character to the data entry.

6. The method of claim 1, further comprising determining a second encryption type for a second normalized data entry from the list of data entries, and inserting a new data entry in the output file for determining a false positive match with the new data entry.

7. The method of claim 1, further comprising binding the fingerprint and the initialization vector the data entry using a lambda calculus operation.

8. The method of claim 1, further comprising sorting encryption values in the output file such that an order of the encryption values does not have one-to-one correspondence with an order of the list of data entries.

9. The method of claim 1, further comprising transmitting the output file to a second computing system.

10. The method of claim 9, wherein a second computing system:
receives the output file from the first computing system, the output file comprising the encryption value;
receives or accesses a second input file, the second input file comprising a second list of data entries;
determines the fingerprint from the output file.

11. The method of claim 10, wherein a second computing system:
identifies, using the fingerprint, a subset of the second list of data entries in the second input file, the subset of the second list of data entries comprising a second data entry;
generates, using the encryption type, a second encryption value for the second data entry;
compares the encryption value with the second encryption value;
determines whether the encryption value matches the second encryption value;
in response to determining the encryption value matches the second encryption value, removes the second encryption value from the second output file or the output file to produce a modified second output file or a modified output file; and
transmits the modified output file or the modified second output file.

12. The method of claim 11, wherein a size of the subset of the second list of data entries is equal to or less than a memory of the second computing system.

13. The method of claim 11, wherein a size of the second list of data entries or the output file is greater than a memory of the second computing system.

14. The method of claim 10, wherein the second computing system:
generates, using the encryption type, a second encryption value for a second data entry in the second input file;
compares the encryption value with the second encryption value;
determines whether the encryption value matches the second encryption value;
in response to determining the encryption value matches the second encryption value, removes the second encryption value from the second output file or the output file to produce a modified second output file or a modified output file; and
transmits the modified output file or the modified second output file.

15. The method of claim 14, wherein the second computing system, prior to transmitting the modified output file or the modified second output file, inserts a second encryption signature in the modified output file or the modified second output file.

16. The method of claim 14, further comprising:
receiving the modified output file or the modified second output file from the second computing system;
determining, using the modified output file or the modified second output file, the initialization vector;
re-receiving or re-accessing the input file;
re-generating, using the encryption type, a third encryption value for a data entry in the input file; and
comparing the third encryption value to a fourth encryption value in the modified output file or the modified second output file.

17. The method of claim 16, further comprising:
in response to determining the third encryption value does not match the fourth encryption value, retaining the third encryption value;
determining a second data entry associated with the third encryption value; and
producing a second output file comprising the second data entry.

18. The method of claim 16, further comprising deleting the encryption signature from the modified output file.

19. The method of claim 16, wherein determining the initialization vector comprises:
determining the fingerprint;
building a fingerprint table using the fingerprint; and
merging the modified output file or the second modified output file with the fingerprint table.

20. A computing system for non-decryptably encrypting data entries, the computing system for:
receiving or accessing an input file, the input file comprising a list of data entries;
generating an initialization vector for a data entry;
generating a fingerprint for the data entry;
generating an encryption signature based on the initialization vector and the fingerprint, the encryption signature being associated with a data session;
determining an encryption type for the data entry;
generating, using the encryption type, an encryption value for the data entry; and
producing an output file comprising the encryption value and the encryption signature, wherein the encryption value cannot be decrypted to produce the data entry.
